(19) United States
(12) Patent Application Publication
(10) Pub. No.: US 2008/0201942 A1
(43) Pub. Date: Aug. 28, 2008

(54) Combining device for the ballplayers of a football playing table

(75) Inventor: Ying-Tse Chen, Tainan Hsien (TW)

Correspondence Address: BACON & THOMAS, PLLC, 625 SLATERS LANE, FOURTH FLOOR, ALEXANDRIA, VA, 22314, US

(73) Assignee: Pai Li Business Co., Ltd., Tainan Hsien (TW)

(21) Appl. No.: 11/709,684

(22) Filed: Feb. 23, 2007

(51) Int. Cl. B23P 19/06

(52) U.S. Cl. 29/805

(57) ABSTRACT

A device for the ballplayer of a football-playing table includes a head and a body combined together. The body is bored with a combining hole with a stepped surface extending downward to form a stop ring, and the stepped surface is cut with two opposite notches. A neck under the head has its lower end fixed with two opposite projections extending outward and respectively matching with the two notches of the stepped surface, having its bottom disposed with an insert pin extending downward. A metallic tube is inserted through the lateral insert hole of the body and bored with a diametrical hole for the insert pin to be inserted therein. In assembling, the neck is first fitted in the combining hole and then turned to let the projections sustain the stop ring and insert the insert pin in the metallic tube to combine the ballplayer with the metallic tube.

### BACKGROUND OF THE INVENTION

1. Field of the Invention

This invention relates a combining device for the ballplayers of a football-playing table, particularly to one, simple in structure, able to save producing cost and maintain ballplayers' external beauty.

2. Description of the Prior Art

A conventional football-playing table, as shown in FIG. 1, has its topside formed with a playing space disposed therein with plural rows of ballplayers pierced together by means of a metallic tube. The ballplayers assembled on two abutting metallic tubes in the midfield of the playing table are disposed face to face. When playing, two operators respectively stand at the left and the right side of the playing table and hold the two metallic tubes to control the ballplayers on the metallic tubes to move rightward and leftward or turn around for blocking the football kicked by the opponent or kicking the football forward to get a goal.

Combining devices for the conventional ballplayers 10 fixed on a metallic tube 20 are generally grouped into two kinds. A first kind of conventional ballplayers 10, as shown in FIG. 1, is formed integral, bored with a lateral insert hole 11 at the location of its chest for a metallic tube 20 to be inserted therethrough. The ballplayer 10 has the front side of its chest bored with a front insert hole 12 at a location corresponding to the metallic tube 20, which is bored with a diametrical hole 21 at a location corresponding to the front insert hole 12 of the ballplayer 10. Thus, when the metallic tube 20 is inserted in the lateral insert holes 11 of the ballplayers 10, with its diametrical hole 21 aligned to the front insert hole 12 of the ballplayer 10, a bolt 22 is inserted through both the front insert hole 12 of the ballplayer 10 and the diametrical hole 21 of the metallic tube 20 and then screwed with a nut 23 at the rear side of the ballplayer 10 to firmly assemble the ballplayers 10 on the metallic tube 20. A second kind of conventional ballplayer 10, as shown in FIG. 2, is to have the body of the ballplayer 10 divided into a front half part 100 and a rear half part 101 combined together by means of a bolt 22. The front and the rear half part 100 and 101 have their inner walls respectively and correspondingly cut with a lateral insert hole 11 for a metallic tube 20 to be inserted therethrough. The two lateral insert holes 11 of the front and the rear half part 100 and 101 have their walls respectively provided with a projection 210 at a location matching with the opposite ends of the diametrical hole 21 of the metallic tube 20. To assembling the ballplayers 10 on the metallic tube 20, firstly, the front and the rear half part 100 and 101 of the ballplayer 10 are respectively held on the opposite sides of the metallic tube 20, letting the two projections 210 respectively engaged in the diametrical hole 21 of the metallic tube 20. Then, the front and the rear half part 100 and 101 of the ballplayer 10 are combined together to fix the ballplayer 10 on the metallic tube 20 by means of bolts 22.

However, the common drawback of the two conventional ways of assembling the ballplayer 10 on the metallic tube 20 is that bolts 22 must be used. In the second conventional assembly way, the bolts 22 still have to be used for combining the front and the rear half part 100 and 101 of the ballplayer 10 together although they are not inserted through the metallic tube 20, thus taking too much time and labor in assembly. In addition, the bolts 22 are exposed to the outer surface of the ballplayers 10, spoiling a ballplayer's external beauty.

### SUMMARY OF THE INVENTION

The objective of this invention is to offer a device for the ballplayer of a football playing table, needless to employ bolts for combining ballplayers with a metallic tube, and able to save producing cost and maintaining the external beauty of the ballplayers.

The feature of the invention is that the ballplayers whose head and body are made separate. Then the body has its topside bored with a combining hole having its inner wall formed with a stepped surface, which extends downward to form a stop ring and is cut with two notches opposite to each other. A neck positioned under the head has its lower outer edge fixed with two projections extending outward horizontally, and respectively corresponding to the two notches of the stepped surface, and has its lower end secured with an insert pin extending downward. A metallic tube is inserted through the lateral insert hole of the body, having its upper side bored with a diametrical hole at a location corresponding to the insert pin of the head for the insert pin to be inserted therein. In assembling, the neck having its two projections respectively aligned to the two notches is fitted in the combining hole of the body, and then the head is turned to move the two projections to position under the lower side of the stop ring and the insert pin is inserted in the diametrical hole of the metallic tube, thus able to firmly combine the ballplayers on the metallic tube without using any bolt.

### BRIEF DESCRIPTION OF DRAWINGS

This invention will be better understood by referring to the accompanying drawings, wherein:

FIG. 1 is a perspective view of a first kind of ballplayers to be assembled with metallic tubes;

FIG. 2 is an exploded perspective view of a second kind of ballplayer to be assembled with a metallic tube;

FIG. 3 is an exploded perspective view of a ballplayer to be assembled on a metallic tube in the present invention;

FIG. 4 is a front view of a first step of assembling the ballplayer on the metallic in the present invention;

FIG. 5 is a front view of a second step of assembling the ballplayer on the metallic tube in the present invention;

FIG. 6 is a front view of a third step of assembling the ballplayer on the metallic tube in the present invention;

FIG. 7 is a front view of a fourth step of assembling the ballplayer on the metallic tube in the present invention;

FIG. 8 is a front view of a fifth step of assembling the ballplayer on the metallic tube in the present invention; and

FIG. 9 is a cross-sectional view of the ballplayer assembled on the metallic tube in the present invention.

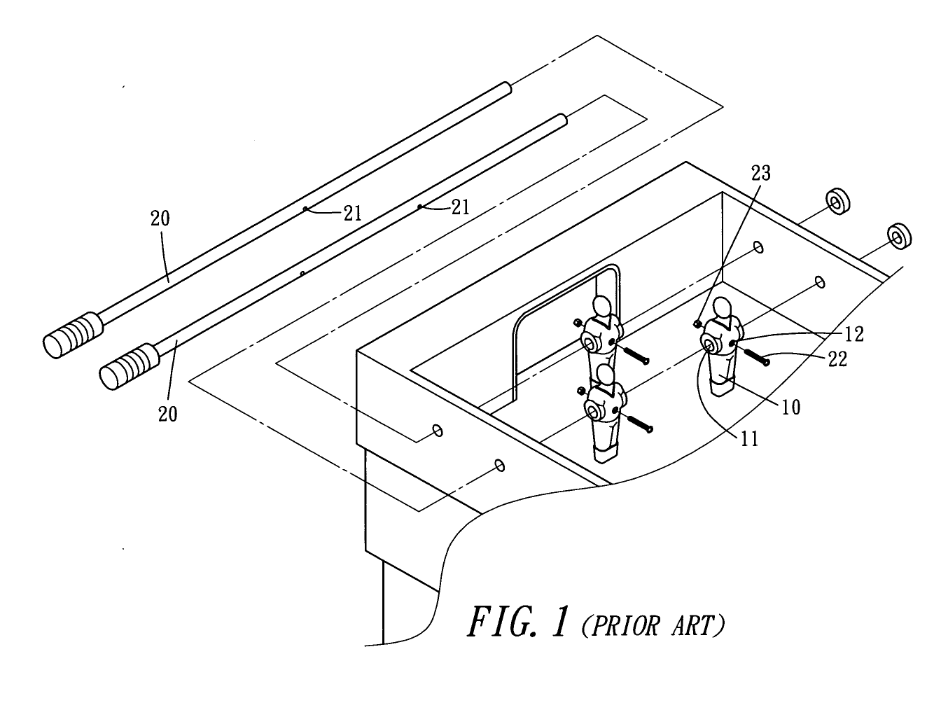

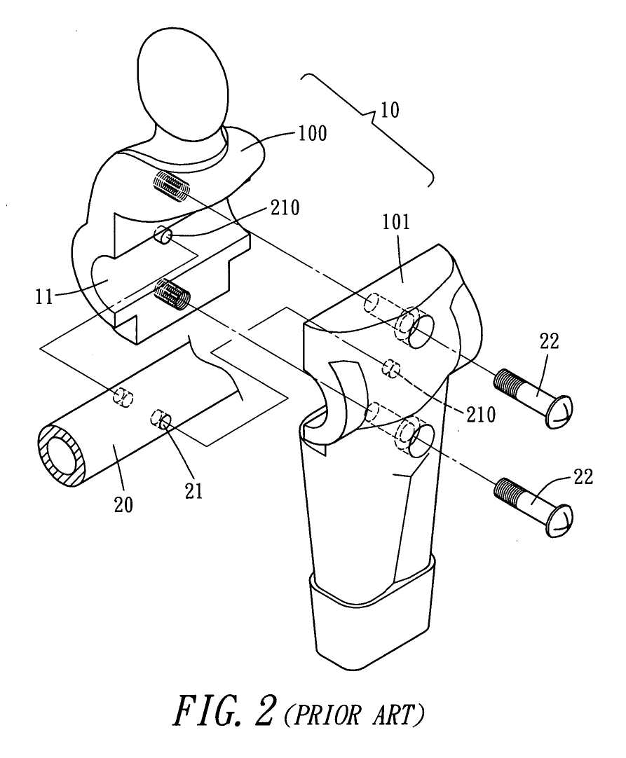

### DETAILED DESCRIPTION OF THE PREFERRED EMBODIMENT

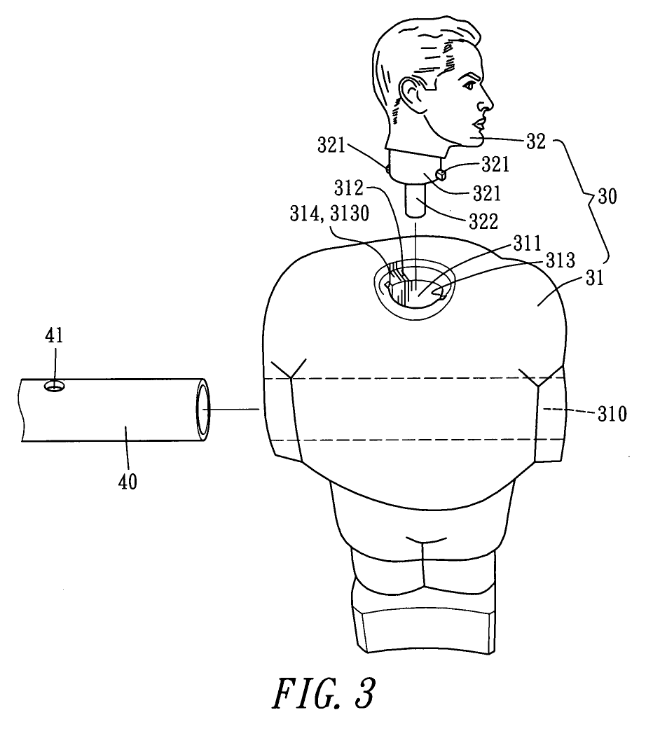

A preferred embodiment of a combining device for the ballplayers 30 of a football-playing table in the present invention, as shown in FIG. 3, includes a body 31 and a head 32 combined together.

The body 31 has its chest bored with a lateral insert hole 310 extending from one side to the other side of the body 31 for a metallic tube 40 to be inserted therethrough. The body 31 has its topside bored in the center with a combining hole 311 having its inner wall extending downward to form an annular stepped surface 312, which has its inner side extending downward and formed with a stop ring 313. The stepped surface 312 is cut with two notches 314 opposite to each other, and the stop ring 313 is bored with two lengthwise openings 3130 respectively corresponding to the two notches 314 of the stepped surface 312.

The head 32 has its lower end formed with a neck 320 having its lower outer wall provided with two opposite projecting blocks 321 extending outward horizontally and respectively matching with the two notches 314 of the stepped surface 312 in the combining hole 311 of the body 31. Further, the neck 320 has its lower end extending downward to form an insert pin 322 with a comparatively small diameter.

The metallic tube 40 to be inserted through the lateral insert hole 310 of the body 31 of the ballplayer 30 is vertically bored with a diametrical hole 41 at a location matching with the insert pin 322 of the head 32 for the insert pin 322 to be inserted therein.

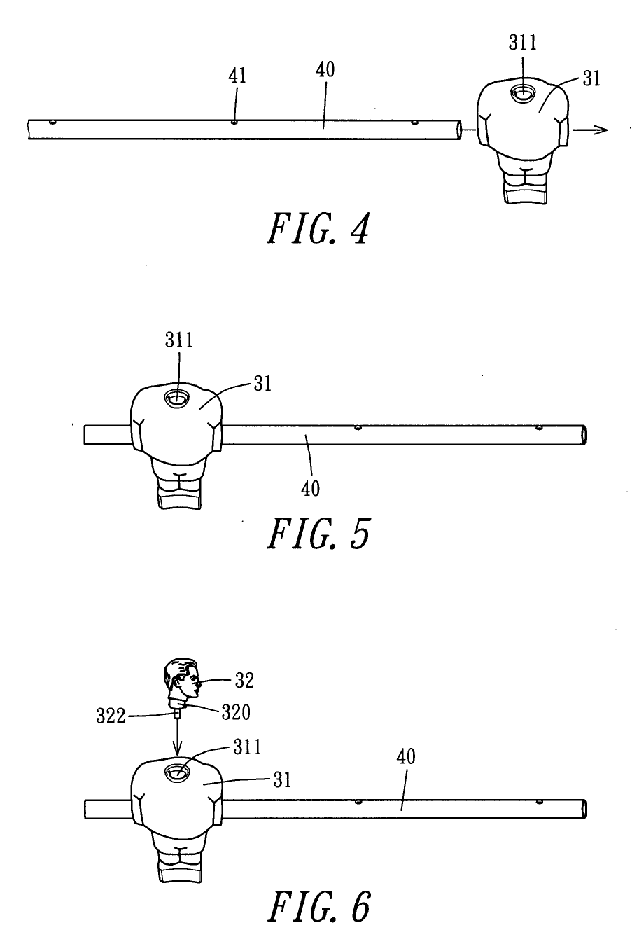

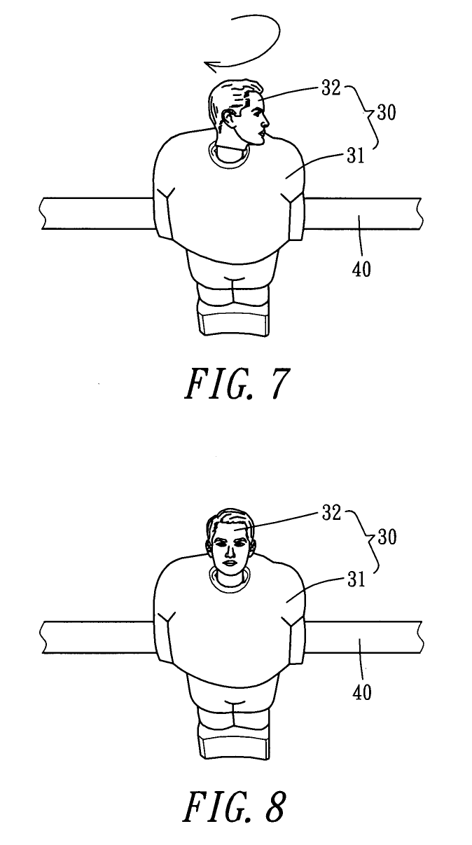

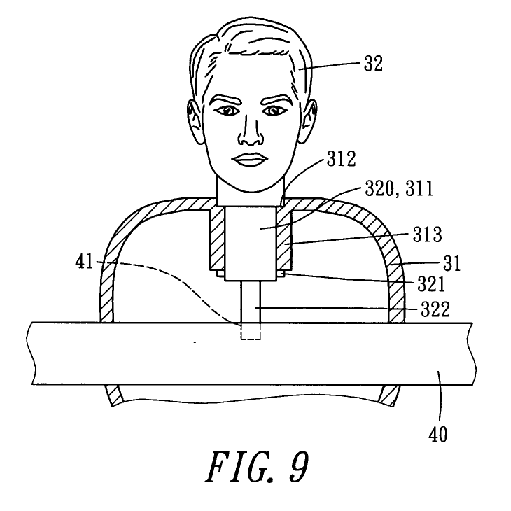

In assembling, as shown in FIGS. 4 to 8, firstly, insert the metallic tube 40 in the lateral insert hole 310 of the body 31, as shown in FIG. 4, and adjust the diametrical hole 41 of the metallic tube 40 to the middle of the body 31, as shown in FIG. 5. Next, the head 32 has its two lower opposite projections 321 respectively aligned to the two opposite notches 314 of the stepped surface 312 in the combining hole 311 of the body 31 and has its neck 320 fitted in the combining hole 311, as shown in FIGS. 6 and 7. Then, move the projections 321 downward along the lengthwise openings 3130 of the stop ring 313 until the head 32 at the upper end of the neck 320 rests on the stepped surface 312 of the body 31. At this time, the two projections 321 of the head 32 are positioned under the stop ring 313 and the insert pin 322 is inserted in the diametrical hole 41 of the metallic tube 40. Subsequently, as shown in FIG. 8, turn the head 32 to actuate the two projections 321 to move away from the openings 3130 of the stop ring 313 and positioned at the bottom edge of the stop ring 313. By means of the projections 321 sustaining the lower edge of the stop ring 313, the lower side of the head 32 and the upper end of the neck 320 can be restrictedly positioned on the stepped surface 312, and thus the head 32 and the body 31 can be firmly combined together, with the head 32 movable to let the face of the ballplayer positioned in a preset direction, as shown in FIG. 9. Since the insert pin 322 is fixedly inserted in the diametrical hole 41 of the metallic tube 40; therefore, the ballplayer 10 can be fixed on the metallic tube 40 to be rotated together with the metallic tube 40, and users can operate the metallic tube 40 for controlling the ballplayers 30 to shift and turn around.

As can be understood from the above description, this invention has the following advantages.

1. It is unnecessary to employ any bolt for combining the ballplayer 30 together with the metallic tube 40 or for assembling the ballplayer 30 itself, simple in assembly and able to save producing cost.

2. No bolt is exposed to the outer surface of the ballplayer, able to keep a beautiful external appearance of the ballplayer.

3. This invention is more practical and original, compared with the conventional the ballplayer.

While the preferred embodiment of the invention has been described above, it will be recognized and understood that various modifications may be made therein and the appended claims are intended to cover all such modifications that may fall within the spirit and scope of the invention.

I claim:

1. A combining device for the ballplayer of a football playing table comprising ballplayers and metallic tubes, said ballplayer having its head and body made separate, said body of said ballplayer having its topside bored with a combining hole for connecting said head of said ballplayer, said combining hole having its inner wall formed with a stepped surface, said stepped surface extending downward to form a stop ring, said stepped surface cut with two notches opposite to each other, said head of said ballplayer having its lower side fixed with a neck, said neck having its lower outer end provided with two projections extending outward horizontally and respectively corresponding to said two notches of said stepped surface of said body, said neck having its central bottom extending downward and formed with an insert pin, said metallic tube inserted through the lateral insert hole of said body, said metallic tube having its upper side bored with a diametrical hole at a location corresponding to said insert pin of said neck for said insert pin to be inserted therein, in assembling said neck of said head fitted in said combining hole of said body by having said two projections respectively aligned to said two notches of said stepped surface, said head turned to move said two projections to be positioned at the underside of said stop ring of said body, said insert pin of said neck inserted in said diametrical hole of said metallic tube to combine said ballplayer together with said metallic tube.

2. The combining device for the ballplayer of a football playing table as claimed in claim 1, wherein said stop ring is bored with two lengthwise openings at the locations respectively matching with said two notches of said stepped surface.

3. The device for the ballplayer of a football playing tube as claimed in claim 1, wherein said neck of ballplayer is turned for an angle to actuate said two projections to move away from said openings of said stop ring and positioned under a lower edge of said stop ring after said neck is fitted in said combining hole of said body, said head and said body fixedly combined together by means of said projecting blocks sustaining the lower edge of said stop ring and the lower side of said head and the upper end of said neck restrictedly positioned on said stepped surface.
